(19) United States
(12) Patent Application Publication
(10) Pub. No.: US 2019/0263200 A1
(43) Pub. Date: Aug. 29, 2019

(54) Pumping Mechanism Insert

(71) Applicant: Benjamin J. Krempel, Saint Charles, IL (US)

(72) Inventor: Benjamin J. Krempel, Saint Charles, IL (US)

(21) Appl. No.: 16/285,983

(22) Filed: Feb. 26, 2019

Related U.S. Application Data
(60) Provisional application No. 62/635,195, filed on Feb. 26, 2018.
(60) Provisional application No. 62/658,855, filed on Apr. 17, 2018.

(51) Int. Cl. B60C 23/12; B60C 5/04; B60C 29/06; B60C 23/00

(52) U.S. Cl. CPC B60C 23/12; B60C 23/004; B60C 29/068; B60C 5/04

(57) ABSTRACT

A self-inflating tire is provided that includes a pneumatic tire having a tread, and a casing, where the tread includes an outer riding surface, wherein the casing includes an inner inflation surface, and an elastic inflation lumen disposed between the casing and the tread, where the inflation lumen has at least one air through-port.

### CROSS-REFERENCE TO RELATED APPLICATIONS

This application claims priority from U.S. Provisional Patent Application 62/635,195 filed Feb. 26, 2018, which is incorporated herein by reference. This application claims priority from U.S. Provisional Patent Application 62/658,855 filed Apr. 17, 2018, which is incorporated herein by reference.

### FIELD OF THE INVENTION

The current invention relates to pneumatic tire inflation. More particularly, the invention relates to at self-inflating pneumatic tire having a compression layer disposed between a tire casing and tire tread.

### BACKGROUND OF THE INVENTION

One of the most efficient pumping designs for self-inflating tires for bicycles is to put the lumen outside of the tread of the tire and centered in the middle of the tire. With this design, the hard, stiff tire compresses the pumping mechanism against the hard pavement. This design is very efficient because most of the load on the wheel presses down on the pavement and therefore on the pumping mechanism. However with this type of design, there are several problems such as the tire ride quality is compromised because the pumping mechanism has a high ridge along the riding surface of the tire and therefore is prone to tracking or can be easily torn, ripped, damaged by elements on the riding surface. A further problem is low durability of the pumping mechanism due to thin wall thickness of the pumping mechanism, and current tire manufacturing processes do not lend themselves to high precision features, such as a pumping mechanism, withstanding the injection molding and vulcanization cycles.

What is needed is a self-inflating pneumatic tire having the compression mechanism disposed between the tire casing and tire tread.

### SUMMARY OF THE INVENTION

To address the needs in the art, self-inflating tire is provided that includes a pneumatic tire having a tread, and a casing, where the tread includes an outer riding surface, where the casing includes an inner inflation surface, and an elastic inflation lumen disposed between the casing and the tread, where the inflation lumen has at least one air through-port.

On one aspect of the invention, the at least one air through-port includes an input port, an output port, or an input/output port (I/O port).

In another aspect of the invention, the inflation lumen includes a closed-end inflation lumen that spans along at least a portion of a circumference of the pneumatic tire.

According to a further aspect of the invention, the inflation lumen includes an open-end inflation lumen that spans along a circumference of the pneumatic tire.

In one aspect of the invention, the tread includes a channel, where the inflation lumen is disposed in the channel.

In yet another aspect of the invention, the pumping mechanism is configured to a tire according to a tubeless tire, or a tubed tire.

According to another aspect, the invention further includes a compression layer that is disposed in a position that includes between the inflation lumen and the tread, or between the casing and the inflation lumen, where the compression layer includes an actuator, where the actuator has a cross-section having a base and a converging tip, where the converging tip abuts an outer surface of the inflation lumen, where the compression layer has a length that spans along at least a portion of a circumference of a pneumatic tire. In one aspect, the actuator includes at least one ridge feature on the converging tip that is transverse to the compression layer length. In another aspect, the compression layer includes an interlocking actuator, where the interlocking actuator has a female actuator disposed on a first side of the inflation lumen and a male actuator disposed on a second side of the inflation lumen, where the first side is opposite the second side, where the interlocking actuator is configured to impart a surrounding-force directed to maintain alignment between the inflation lumen and the actuator. In a further aspect, the compression layer includes a lower hardness than a hardness of the tread.

According to one aspect of the invention, the inflation lumen is disposed along at least a portion of a circumference of the pneumatic tire.

In another aspect the invention further includes an inflation lumen protection layer disposed between the inflation lumen and the tread.

In a further aspect of the invention, the inflation lumen includes a block shape cross-section, where the block shape cross-section has a channel forming the lumen.

According to one aspect, the invention further includes a valve, where the valve includes a membrane valve, a 3-way valve, or a 2-way valve. In one aspect, the current embodiment further includes a connector tubing disposed between the lumen and the valve. In one aspect, the connector tubing includes an accumulator, where the accumulator stores a volume of air between the lumen and the valve. In a further aspect, the valve is connected to an inner tube, where the inner tube connection includes a controller connected between the inflation lumen and the valve of the inner tube.

According to one aspect, the invention further includes a valve and an actuator pressure governor, where the actuator pressure governor has an adjustable air input/output port.

In another aspect, the invention further includes a controller that includes a removable controller, an adjustable pressure controller, or a fixed pressure controller. In one aspect, the controller is disposed in a location inside an inner tube.

### BRIEF DESCRIPTION OF THE DRAWINGS

FIGS. 1A-1B show a self-inflating tire system that includes a tire casing, a tire tread, an inflation lumen, and an compression layer, where the inflation lumen is disposed between the casing and the tread, according to one embodiment of the invention.

FIGS. 2A-2F show the inflation lumen embodied in a housing having a block-shape cross-section, according to one embodiment of the invention.

FIGS. 3A-3B show a pumping mechanism that includes the inflation lumen, and the compression layer fittably inserted between the casing and tread to a lumen channel, according to one embodiment of the invention.

FIGS. 4A-4B show one embodiment of the compression layer, according to one embodiment of the invention.

FIGS. 5A-5B show a compression layer incorporated between the casing and tread, where the compression layer includes interlocking features, according to one embodiment of the invention.

FIGS. 6A-6C show a closed-end pumping mechanism, according to one embodiment of the invention.

FIGS. 7A-7B show a three-way valve in a controller, where the three-way valve is constructed by utilizing two standard tire check valves, according to one embodiment of the invention.

FIGS. 8A-8B show how the closed-end pumping mechanism can be optimized in different ways compared the open-end systems because of its different operating principle, according to one embodiment of the invention.

FIGS. 9A-9D show an adjustable pressure diaphragm valve for an adjustable pressure valve, according to one embodiment of the invention.

FIGS. 10A-10D show an adjustable pressure diaphragm valves for an adjustable pressure valve, according to one embodiment of the invention.

FIGS. 11A-11D show alternate embodiments of the tire port connections, according to one embodiment of the invention.

### DETAILED DESCRIPTION

The invention provides a self-inflating tire system and a pressure regulation system for self-inflating bicycle tires, which controls the air pressure in the system. The self-inflating tire system uses mechanical energy from the rolling and deformation of the tire to push air into the tire. Once the desired pressure is reached the pressure regulation system stops the system from pumping.

According to one embodiment, the pumping mechanism is manufactured separately from the tire, where the pumping mechanism includes a compression lumen and control system, where the tire is designed with features for accepting the pumping mechanism. In this embodiment, the pumping mechanism is designed to be integrated into the tire to provide a uniform riding surface having sufficient rubber on the riding surface to protect the pumping mechanism from harm for the designed tire life. In this embodiment, the pumping mechanism includes a lumen within a polymer or rubber bulk layer, where the compression lumen is disposed circumferentially to an outer surface of a tire casing, yet embedded with or beneath the tire tread. In this example, the compression lumen is incorporated with the tire tread according to vulcanization, adhesion, extrusion, or molding technologies.

According to other aspects, the invention further includes a compression layer that is disposed in a position that includes between the inflation lumen and the tread, or between the casing and the inflation lumen, where the compression layer includes an actuator, where the actuator has a cross-section having a base and a converging tip, where the converging tip abuts an outer surface of the inflation lumen, where the compression layer has a length that spans along at least a portion of a circumference of pneumatic tire. In one aspect, the actuator includes at least one ridge feature on the converging tip that is transverse to the compression layer length. In another aspect, the compression layer includes an interlocking actuator, where the interlocking actuator has a female actuator disposed on a first side of the inflation lumen and a male actuator disposed on a second side of the inflation lumen, where the first side is opposite the second side, where the interlocking actuator is configure to impart a surrounding-force on the inflation lumen. In a further aspect, the compression layer includes a lower hardness than a hardness of the tire.

Turning now to the pumping mechanism, the current invention provides a pumping mechanism between the casing and the tread of the tire. Pneumatic tires such as bicycle tires carry their load through the tension of the fibers in the casing. This tension plus the surrounding materials create a stiff, but pliable region. The current invention places a pumping mechanism between the outer surface of the casing and the tread. The load imparted on the tire is transferred from the casing to the pumping mechanism, where the pumping mechanism compresses as the tire rolls on the ground surface. These dynamics causes the lumen to collapse and push air forward through the lumen and into the control system. As the wheel rotates, the load is removed from the pumping mechanism and the lumen rebounds to its original shape, where air is drawn in for the next pumping cycle.

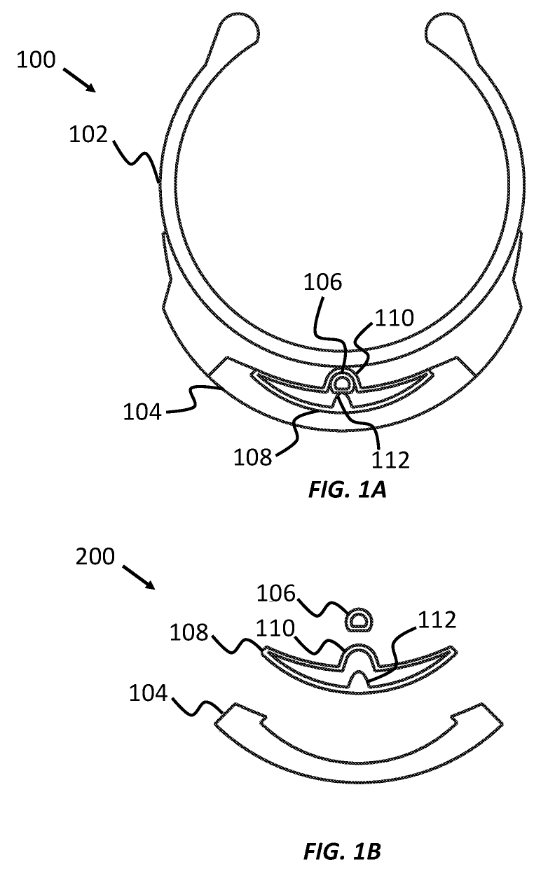

Turning now to the figures, FIGS. 1A-1B show an example of one embodiment of the invention, where shown is the self-inflating tire system 100, that includes a tire casing 102 (also referred to as a carcass), a tire tread 104, an inflation lumen 106, and an compression layer 108 that includes an actuator 112. Here, the inflation lumen 106 is disposed between the casing 102 and the tread 104, where the compression layer 108 has a protection layer 110 for positioning and retaining the inflation lumen 106 at a desired position along the outer surface of the casing 102, and an actuator tip 112 having a base that converges at the top (see FIG. 1B). In the current embodiment, the inflation lumen 106, the compression layer 108 and the protection layer 110 are collectively referred to as the pumping mechanism 200.

According to the current invention, the inflation lumen 106 material includes any one of, or a combination of: natural rubber, synthetic rubber, high molecular weight, flexible polyvinyl chloride (PVC), standard flexible PVC, peroxide cured silicone, thermoplastic vulcanizate (TPV), and thermoplastic elastomer (TPE) Viton™ rubber.

According to the current invention, the compression layer 108 material includes any one of, or a combination of foamed natural rubber, foamed synthetic rubber, foamed thermoplastic PU, foamed polyurethane, open cell foam, and closed cell foam.

There are many benefits to this construction. For example, separate construction of the pumping mechanism 200 and tire allows much more complexity to be built into the tire assembly. Typically, tires go through a vulcanization process where high heat and pressure force the unformed, unvulcanized rubber into the shape and profile of the finished product.

Delicate elements such as the pumping mechanism 200 would otherwise have difficulty withstanding the high heat and pressure of the process without deformation.

Another advantage of the current invention is that the pumping mechanism 200 is uniform around the major circumference, or at least a portion of the circumference of the wheel; this maintains the uniform riding surface of the tire, resulting in a high quality of ride.

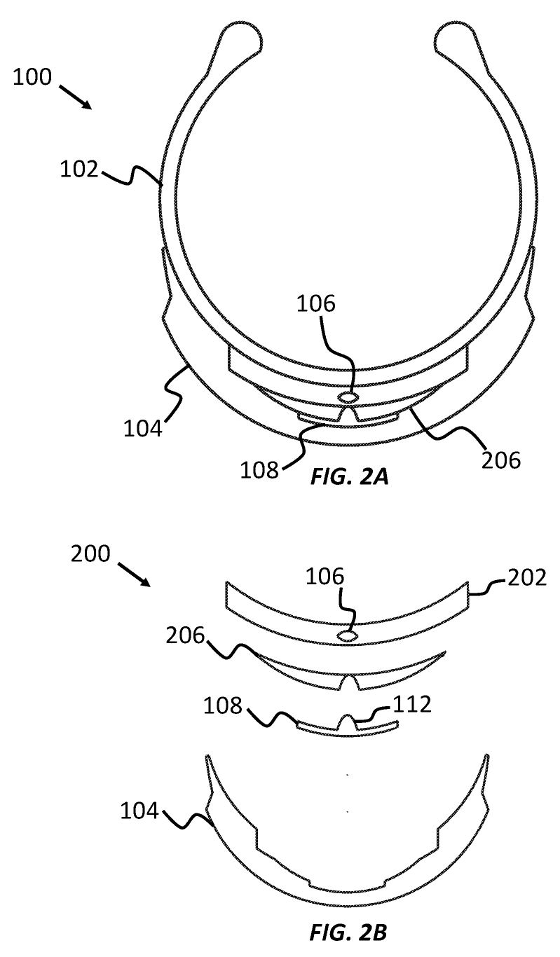

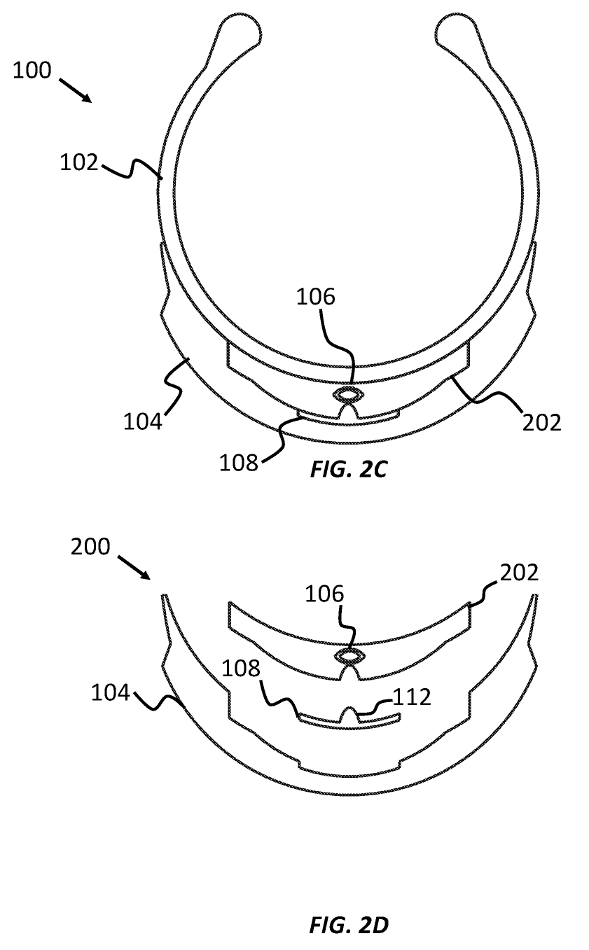

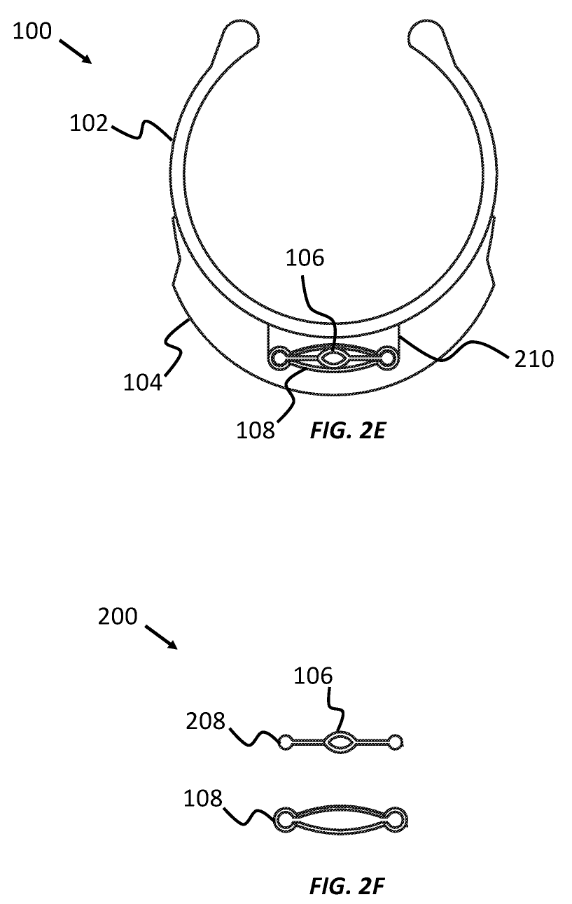

FIGS. 2A-2F show another embodiment of the invention, where the inflation lumen 106 is embodied in a housing 202 having block-shape cross-section. Further shown is a soft rebound material 206, where the soft rebound material 206 can be a foam material or an air pocket. The pumping mechanism 200 must also have the compression layer 108. This includes an open space, or a rebound material 206 made of a relatively easily compacting material that concentrates and focuses the load of the tire on the inflation lumen 106, compression layer 108, and actuator tip 112. In this way, a sufficiently large amount of force can be utilized to collapse the inflation lumen 106. The rebound material 206 may be a space or it may be one or more materials that occupy the space such as foam, air or other easily crushable, compressible materials. FIGS. 2C-2D show the rebound material 206 as a foam or elastic material that can be located surrounding, or anywhere near the inflation lumen 106 and the compression layer 108. The wider the compression layer 108 and rebound material 202, the more downward force that can be captured to compress the inflation lumen 106. The rebound material 202 also reduces the tires resistance to lateral forces during riding and so must be designed with both tire handling and pumping efficiency in mind. FIGS. 2E-2F show a further embodiment of the invention, where the inflation lumen 106 further includes stabilizing features 208 disposed horizontally on opposing sides of the inflation lumen 106. In this embodiment, the compression layer 108 and inflation lumen 106 are disposed between the tire casing 102 and the tread 104, where the compression layer 108 abuts an intermediary casing layer 210. The embodiment shown in FIGS. 2E-2F do not require the actuator tip 112, where the compression layer 108 envelopes the inflation lumen 106 and fittedly surrounds the stabilizing features 208 to position the inflation lumen 106 to the center of the compression layer 108 for optimum compression. In FIGS. 2E-2F, the compression layer 108 captures the inflation lumen 106 horizontally and then presses on the inflation lumen 106 from the top and bottom surfaces.

The compression layer with a raised surface and block lumen, such as in FIGS. 2A-2D are an advantageous design because the inflation lumen 106 and actuator tip 112 can be configured to almost any geometry and cross-sectional area. The smaller the inflation lumen 106 cross-section, the less force and travel required to compress the air in the inflation lumen 106. This embodiment could be advantageous in high-use applications or applications where it is advantageous to minimize the size of the pumping mechanism. Embodiments with a tube configured inflation lumen 106, that is, where the inflation lumen 106 has distinct inside diameters and outside diameters are limited in their durability and pressure ratings due to the thickness of the tube wall. Tubes with thicker wall thickness are more durable but also require more force to compress. The block inflation lumen 106 as shown in FIGS. 2A-2D have relatively thick wall construction on all sides except for where it contacts the raised surface of the actuator tip 112. This embodiment therefore permits smaller inflation lumen 106 cross sectional areas without increasing the force required to compress the inflation lumen 106 or reducing the durability of the pumping mechanism 200.

In another embodiment of the invention the tread may have different layers of materials. For example different layers to indicate wear. This can be done through different layers of multicolor rubber. For example the color may start out black then go to yellow then to red. Other layered materials may include Kevlar or other reinforcement material to protect against puncture.

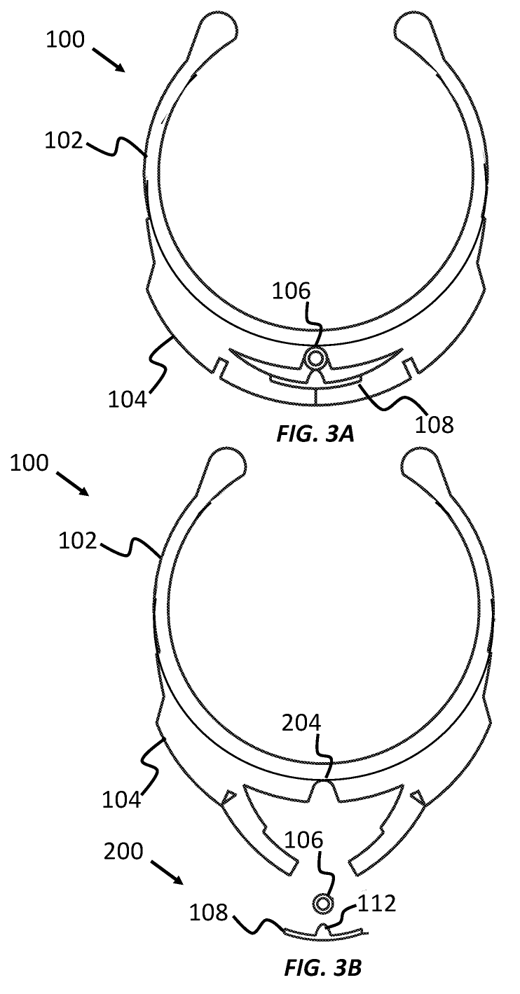

FIGS. 3A-3B show a further embodiment of the invention, where the pumping mechanism 200 includes the inflation lumen 106, and the compression layer 108. In the current embodiment, the pumping mechanism 200 is fittably inserted between the casing 102 and tread 104 to a lumen channel 204 through an open seam in the outer tread 104, where the seam is then bonded to encase the pumping mechanism 200.

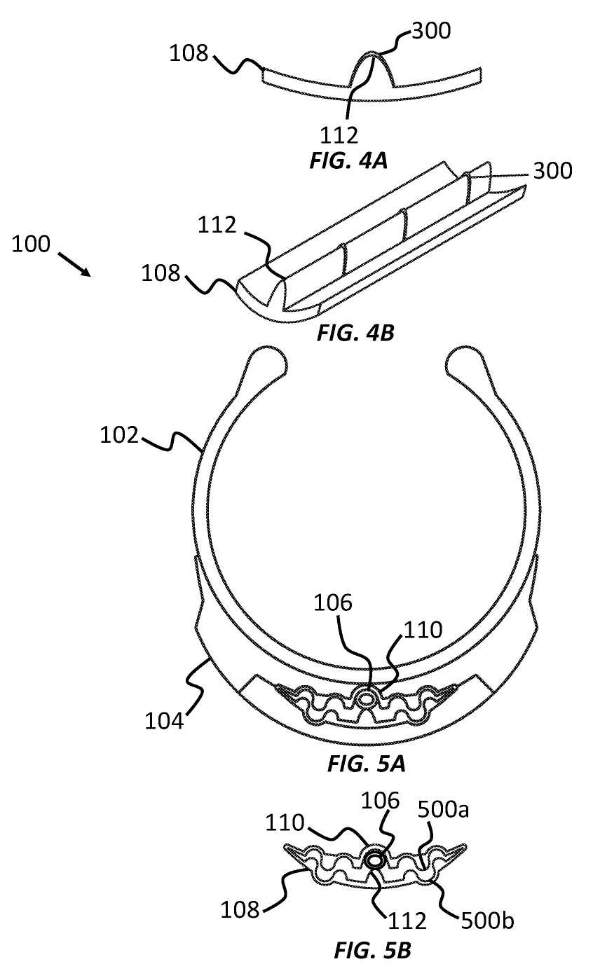

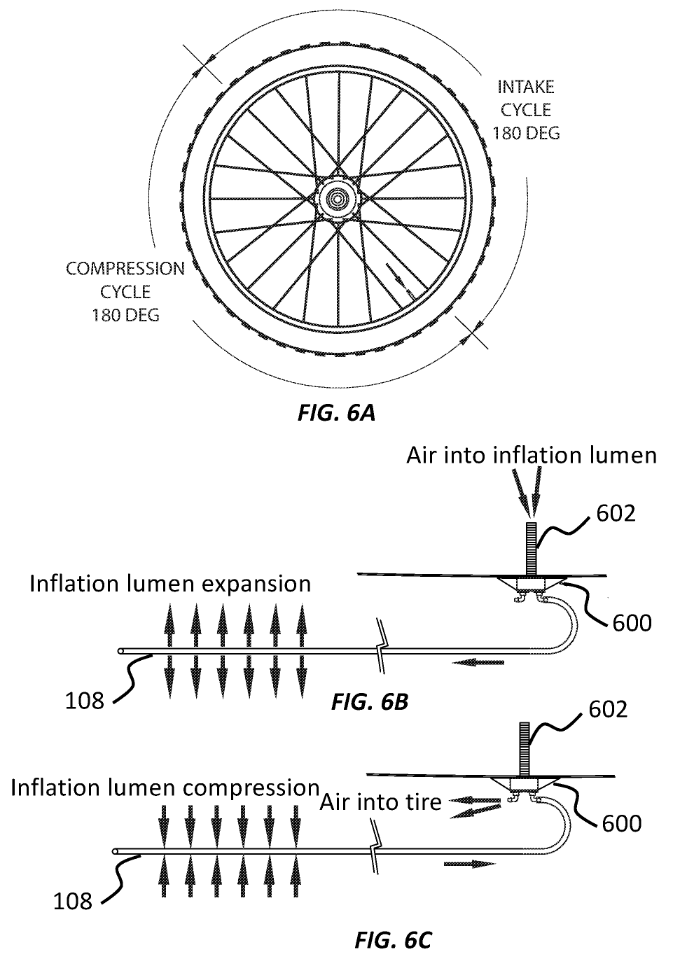

FIGS. 4A-4B show one embodiment of the compression layer 108 and actuator 112. FIG. 4B shows a perspective view of the compression layer 108, where the actuator tip 112 is shown having a series of tip ridges 300 configured to sequentially actuate and compress the inflation lumen 106 as the wheel rolls on a surface. The tip ridges 300 enhance the efficiency in the movement of the air along the inflation lumen 106, where the raised surfaces of the tip ridges 300 ensure that the inflation lumen 106 closes and seals and therefore pushes the air forward, which is especially useful in road bike and other high-pressure applications.

FIG. 5A shows a compression layer 108 having a protection layer 110 region disposed between the casing 102 and the inflation lumen 106, where the inflation lumen 106 remains incorporated between the casing 102 and tread 104. In this embodiment, the compression layer 108 includes interlocking features 500a/500b. The interlocking features 500a/500b facilitate in focusing the compression energy of the actuator tip 112 directly onto the compression lumen 106, while preventing any misalignment of the actuator tip 112 on the compression lumen 106 when the tire rolls along an off-camber, angled, or rough surfaces.

The inflation lumen 106 is an elastic and compressible tube which provides the spring force for drawing in air in the intake cycle. During the compression cycle, the inflation lumen 106 is compressed, which pushes the air through the system. To have a balanced and uniform wheel, it is desirable to have the inflation lumen 106 completely encircle the outside of casing 102 and beneath the tread 104. However, it can completely encircle the casing 102 or only partially encircle the casing 102. The inflation lumen 106 can also completely encircle the casing 102 but only be active for a portion of its length. For the closed-end inflation lumen 106, for example, the active section shown in the drawing only occupies 180-degrees. The other 180-degrees of the inflation lumen 106 would be of similar density and material so that there is no noticeable difference between the two sections for the rider.

The compression layer 108 and actuator tip 112 push on the inflation lumen 106 from one or more sides to cause it to compress. The actuator tip 112 may be a raised surface as shown in FIGS. 2A-2D where it pushes into the lumen from only one side to compress it. In other embodiments such as the embodiment shown in FIGS. 5A-5B the compression layer 108 and actuator tip 112 pushes on the inflation lumen 106 from multiple sides.

An open-end pumping mechanism is shown in FIG. 8A. In this embodiment, the open-end pumping mechanism has two ports for the air to both enter and exit. That is to say air enters through a first port, is compressed, and then exits through a second port. In some designs the port is a dedicated entrance and a dedicated exit. In other embodiments the two ports are interchangeable and the function of the port is dependent upon the orientation of the tire.

Ideally, the pumping mechanism completely encircles the major diameter of the tire. This is beneficial because it preserves the uniform ride of the tire. It is possible, however, to limit the active section of the pumping mechanism. This would be desirable in high usage applications for example where the pumping mechanism has a pumping volume much greater than that required to offset air loss from diffusion. Bike sharing would be an example of this. In this case the active length of the pumping mechanism could be reduced to any fraction of the circumference, for example 120-degrees or 180-degrees of the tire major diameter. This would also reduce the incidence of puncture and increase reliability because a portion of the pumping mechanism would no longer be susceptible to puncture.

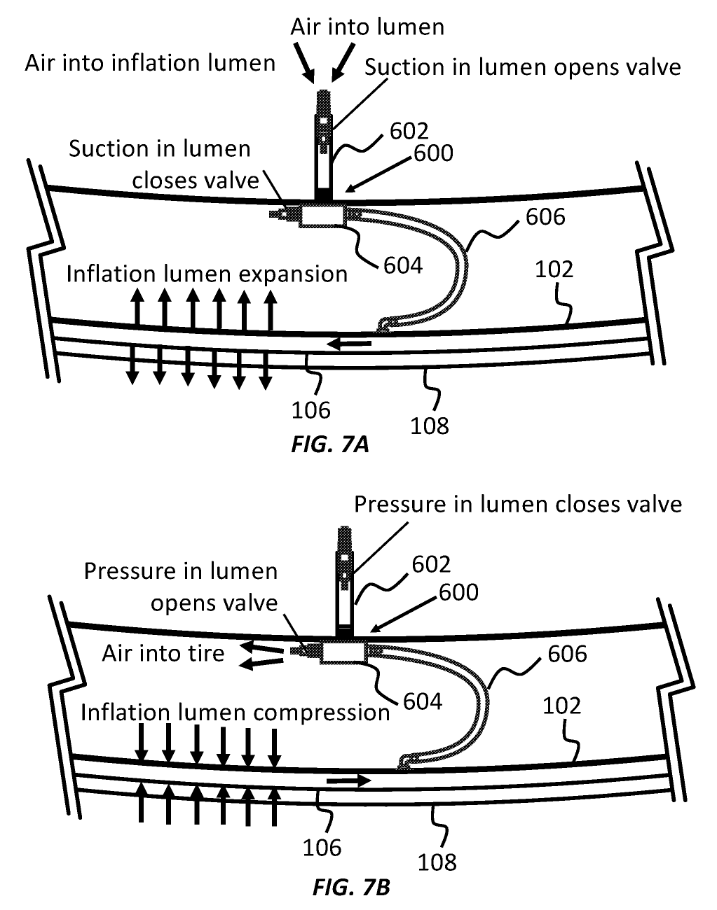

The current invention includes a closed-end pumping mechanism shown in FIG. 8B and FIGS. 7A-7B, where there is only a single port connecting the pumping mechanism 200 to a controller 600, where only the inflation lumen 106 of the pumping mechanism is shown for clarity of illustration. In this embodiment air is drawn in through the valve stem 602 and into the inflation lumen 106 of the pumping mechanism. The flow of air is reversed during the compression cycle and a three-way valve redirects the flow of air into the tire.

Essentially, the air in the inflation lumen 106 is compressed and pushed out of the inflation lumen 106 from the same end it entered the inflation lumen 106. This design significantly reduces the complexity of the pneumatic circuit because is it only requires one pneumatic passageway between the tire and the controller. Having only one passageway through the tire opens up great flexibility of the connection between the tire and the inner tube.

FIGS. 7A-7B show one embodiment of the invention that includes a three-way valve in the controller 600, where the three-way valve is constructed by utilizing two check valves. In this case the first check valve is pneumatically connected to the atmosphere on one side and pneumatically connected to the closed-end inflation lumen 106 and the second check valve on the other side. The second check valve pneumatically connects the inflation lumen 106 and the first check valve on one side and the pressurized chamber of the tire on the other side. In some cases there is an air accumulator located where the first check valve, the second check valve and the closed-end inflation lumen 106 join. In some embodiments a connector tubing joins the inflation lumen 106 to an accumulator 604, where alternatively, the connector tube is large enough to at least partially perform the function of an accumulator 604. The accumulator 604 allows the three elements to physically connect and improves the performance of the valves' actuation by allowing a greater mass of air to collect and operate the valves. When the inflation lumen 106 is compressed and released, it creates a vacuum, which opens the first check valve. Atmospheric air is drawn in through the valve stem and passes through the first check valve. The inflation lumen 106 fills up with air during the rotation of the tire. The tire continues to rotate and soon begins to compress the inflation lumen 106 starting with the closed end. As the air in the inflation lumen 106 is compressed, it locks the first check valve closed. The pressure in the inflation lumen 106 builds until it is great enough to open the second check valve, which pushes air into the chamber of the tire. Once the tire rolls past the open-end of the inflation lumen 106 the lumen begins to pull in air and drops the air pressure at both check valves. The pressure drop causes the first check valve to open and the second check valve to close. The cycle then starts again.

The elements of the three-way control valve can be located anywhere in the system. For example in the embodiment shown in FIGS. 7A-7B both check valves, the accumulator 604 and the connector tubing 606 are all located near the valve stem at the top of the inner tube. However the design could also have the three-way valve closer to the riding surface if that was determined to be beneficial. The positioning of the two check valves could also take multiple configurations. For example in FIGS. 7A-7B the check valves are at 90 degrees to each other. They could also be vertically positioned inline or even horizontally positioned. Ideally the connector tubing is as short as possible because the air in the length of the connector tubing 606 is not compressed by the pumping mechanism 200 during operation and therefore leads to performance losses. The cross-sectional area of the connector tubing can also be larger than the cross-sectional area of the lumen so that the connector tubing acts as an accumulator. This could minimize the combined volume of the connector tubing and accumulator and allow the system to operate more efficiently. In one embodiment the connector tubing 606 is bellowed to offer stress relief the connector tubing 606 and to minimize the length of the tubing at the same time.

FIGS. 8A-8B show how the closed-end pumping mechanism can be optimized in different ways compared the open-end systems because of its different operating principle. For example the pumping cycle in both types must first draw in air from the atmosphere and second push compressed air into the tire chamber. The open-end pumping mechanism is able to do both of these steps in parallel. As soon as a section of inflation lumen 106 passes the contact patch, the inflation lumen 106 immediately begins to draw in air again from the atmosphere. And so, as shown in FIG. 8A, one rotation of the tire yields almost 360 degrees of both drawing in air and pushing compresses air into the tire chamber. The closed-end system, however, performs both of these functions in series. For example if the active, closed-end pumping mechanism goes half way around the tire or 180 degrees, then the inflation lumen 106 will draw in air for 180 degrees and push compressed air into the tire for 180 degrees. In this scenario comparing the two pumping mechanisms, the open-end pumping mechanism will pump twice as much air per revolution as the closed-end system. This is because the closed end inflation lumen 106 extends only 180 degrees as compared to 360 degrees for the open-end system. FIG. 8B shows a closed-end pumping mechanism that goes completely around the tire and only has 180-degrees of active pumping mechanism. The closed-end system needs some dwell time to allow air to be sucked into the system. In spite of the different operating principles, the closed-end pumping system is still advantageous because most cycling applications do not require a large air pumping capacity. Diffusion acts very slowly so in most cases even a limited cycling distance is enough to bring the tire pressure back to the desired range.

Another important aspect of the closed-end pumping mechanism is that it does not need to be unbalanced. The pumping mechanism may go completely around the tire or it may go partially around the tire. A pumping mechanism can be designed to completely encircle the tire and only have a portion of the pumping mechanism active. In this way the invention can be optimized for uniform ride, balance and ease of manufacturing while at the same time limiting the degrees or length of the active pumping mechanism. The inflation lumen 106 of the pumping mechanism 200 could be plugged, clamped, glued, terminated or use any other method to limit the length of the active pumping mechanism.

The pumping mechanism 200 can be similar in form to open-end designs in that it can be slightly stretched and then glued or vulcanized into place in the channel on the tire (see FIGS. 3A-3B for example). The pumping mechanism 200 can be permanently attached to the tire or releaseably attached to the tire. It can be located in a channel in the tire as shown in FIGS. 3A-3B or underneath the complete tread. The pumping mechanism 200 can be located and assembled in any other manner that is being used by open-end pumping mechanisms.

Although the closed-end inflation lumen 106 design can be used for almost any self-inflating tire, the invention has been shown in the embodiment where the pumping mechanism 200 is located outside the casing 102 of the tire. The pumping mechanism 200 connects to the inner tube through a single port, which passes through the casing of the tire.

The inner tube contains a corresponding port so that the pneumatic connection between the inner tube and tire is made. In one embodiment the male connector is part of the pumping mechanism 200 and the female connector is part of the inner tube. In other embodiments the male/female connectors can be reversed. Having the male connector attached to the pumping mechanism 200 has the advantage of not introducing any raised elements outside of the casing and therefore potentially offers a smoother ride. In the case where the application is tubeless all of the same elements are included in the system only they are not packaged within an inner tube.

The current invention uses flexible tubing to join the different elements together. The overall flow of air through the system can be seen in FIGS. 8A-8B the air control circuit diagram. The diagram shows the overall flow of air into the system beginning with air entering the valve stem and finishing with the air entering the inner tube or pressurized chamber of the tire. Air enters through the valve stem and into a first air passageway in the control module. The first air passageway in the control module provides a conduit for the air to the low-pressure lumen. The control module controls whether the first air passageway is open or closed. If the first air passageway is open, air can entire the system and increase the pressure in the tire. If the first air passageway is closed no air can enter the system. Air leaves enters the low-pressure lumen and connects to the pumping mechanism. As the tire rolls on the pavement, the air is compressed in the pumping mechanism and exits the pumping mechanism into the high-pressure lumen. The high-pressure lumen transfers the air to a second air passageway located in the control module. The second air passageway terminates with a check valve mounted in the control module.

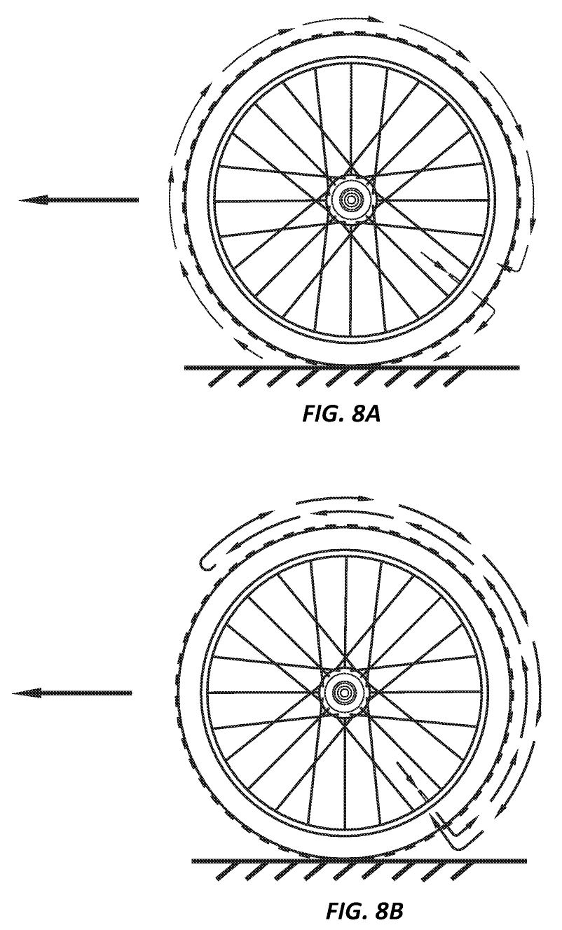

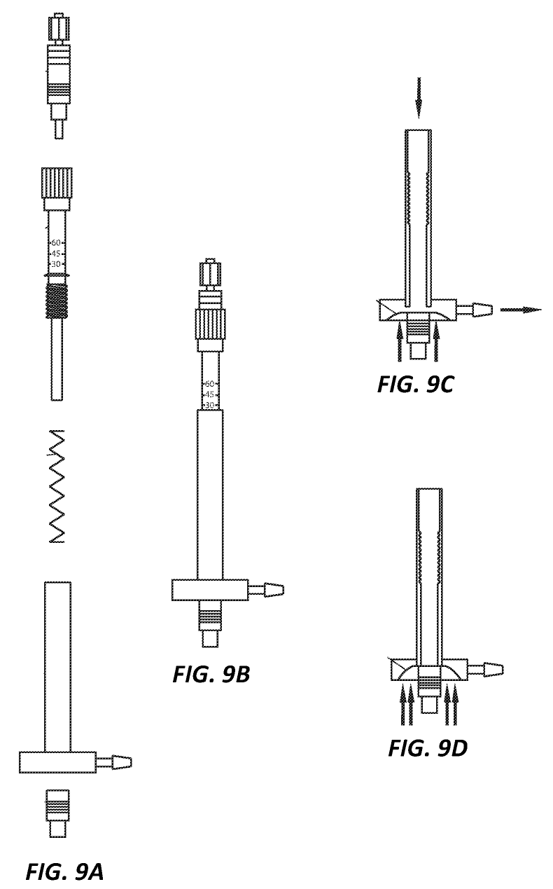

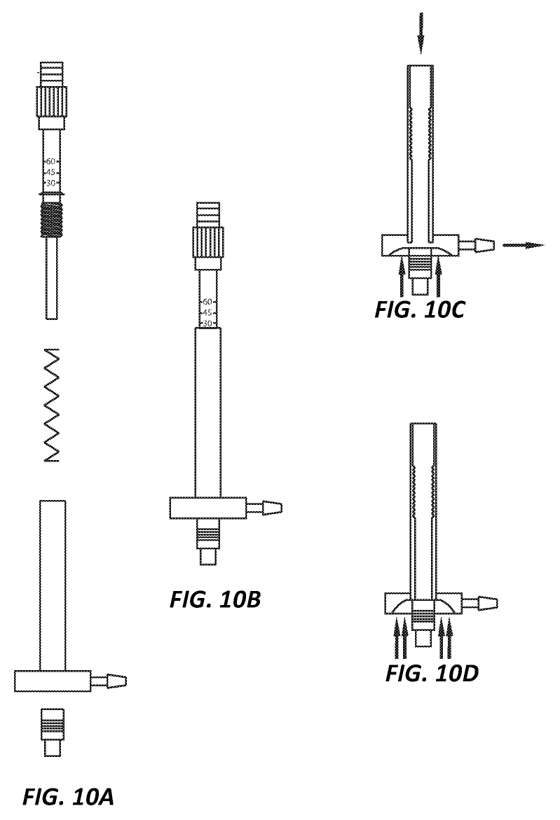

FIGS. 9A-9D and FIGS. 10A-10D show some example embodiments of different adjustable pressure diaphragm valves, where FIGS. 9A-9D show an adjustable pressure presta valve for a closed-end pumping mechanism, and FIGS. 10A-10D show an adjustable pressure presta valve for an open-end pumping mechanism. Here the valve includes an actuator pressure governor, where the actuator pressure governor has an adjustable air input/output port.

The tires used is this system can be manufactured on current equipment found in industry. That is to say they are of the same standard sizes and use the same construction methods. Because most of the high precision elements of the system are located in the pumping mechanism, the manufacturing processes for the tire remains mostly unchanged. In the embodiments where the tire has a channel to accept the pumping mechanism. The channel is approximately 5-20 mm wide. In certain embodiments, the pumping mechanism is adhered in its position in the between the casing and the tread either through vulcanization or adhesion.

One of the advantages of the system is that that self-inflating tire can be manufactured on existing industry equipment. Typically, in bicycle tire manufacturing the components of the tire including casing, bead and tread rubber are assembled and then placed in a mold for vulcanization. The heat and pressure from the mold force the rubber into its final shape and the raised edges and profile of the tread are formed. The typical vulcanization process would damage the pumping mechanism so the invention uses two methods to incorporate the pumping mechanism into the tire.

In the first method the casing of the tire and the tread are assembled and vulcanized independently of each other. FIGS. 2B-2D show exploded views of the tread 104, pumping mechanism 200 and the tire tread 104. In these embodiments, the pumping mechanism 200 is assembled and joined to the tread 104. The pumping mechanism-tread assembly is then joined to the casing 102. The elements can be joined using adhesive or vulcanization techniques already found in the tire industry. For example, some bicycle tires already adhere the tread to the tire post-vulcanization. The trucking industry uses these same techniques to retread tires.

The second method of assembly is shown in FIGS. 3A-3B, which form the tire all in one piece, including the tread, and create a cavity for the pumping mechanism. FIG. 3B shows the tire cross-section with the pumping mechanism cavity 204 in the open position. The pumping mechanism 200 is then placed into position in the cavity and the seam is joined either through the use of adhesives or vulcanization. This method is advantageous in that it allows the entire tire, including the tread, to be vulcanized at the same time. It also allows the same rubber compounds to be used for the tread 104 and casing 102.

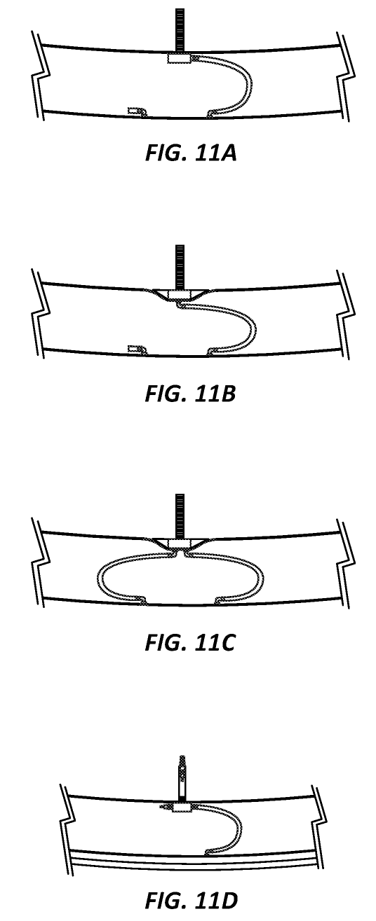

The self-inflating tire has one or more ports to pneumatically join the tire to the inner tube. The in this embodiment, the ports include a tire low-pressure port and a tire high-pressure port. FIG. 11A, where FIGS. 11A-11D show alternate embodiments of the tire port connections. In the case where the design is inner tubeless, the tire ports pneumatically attach directly to the connector tubing 606. The tire ports in one embodiment are barbed connectors made of high durometer materials such as plastic or metal that are co-manufactured with a rubber flange. Metals such as brass or steel or any other metal can be used in the application. In one embodiment the high durometer material is joined to the rubber so that the high durometer material sits 1-3 mm above the inside surface of the tire. In another embodiment the high durometer material comprises a flange and is at least in part over molded by the rubber material. It is advantageous that the port bonds horizontally to the inflation lumen and do not require a barbed fitting to be inserted into the lumen of the pumping mechanism. A barbed fitting would be prone to leakage and poor ride characteristics due to the constant deformation of the tire during riding and might create the feel of riding over a bumpy surface.

In one embodiment the tire ports have a fiber layer which strengthens the casing in the area where the port pushes through the casing. The fibers may be of nylon, cotton or any other load bearing material.

According to the invention, the design has at least one hole through the casing of the tire.

As described earlier, a check valve is located in the control module which is near the valve stem and away from the riding surface. It is desirable to have the check valve as close as possible to the end of the pumping mechanism, but this would bring it close to the riding surface which would expose the check valve to potential damage. High-pressure applications might favor a check valve closer to the end of the pumping mechanism. Embodiments where reliability or cost should be optimized, favor the check valve near the valve stem. The control module comprises a mechanism to control the pressure inside the chamber of the tire or inside the inner tube. The control module may be partially inside the inner tube or partially outside the inner tube. The control module may contain a check valve or it may not. The current invention works for tubeless tires as well as tires utilizing inner tubes

In the embodiments in FIGS. 9A-9D and FIGS. 10A-10D, turning the valve stem adjusts the pressure in the tire. In one embodiment the valve stem has only one lumen or passageway which goes directly to the pumping mechanism. One embodiment uses a diaphragm valve to close the passageway so new air cannot enter into the pumping mechanism. The diaphragm valve works by employing an elastomeric diaphragm which deforms as the pressure in the tire increases. The elastomeric diaphragm is pneumatically connected to the pressurized chamber of the inner tube or tire. To stop the entry of new air into the tire the diaphragm pushes up against the inlet adjuster thereby closing off the passage to new air. In one embodiment the distance between the diaphragm and the inlet adjuster is fixed. In another embodiment the inlet adjuster can be turned to increase or decrease the distance between the diaphragm of the valve and the inlet adjuster to change the pressure setting on the system.

In the case where the embodiment uses an inner tube, the control module may be releasably attached to the inner tube. In one embodiment the inner tube has three ports. The first port connects the inner tube low-pressure port to the tire. The second port connects the inner tube high-pressure port to the tire. The third port connects the inner tube to the control module. In another embodiment the inner tube has two ports. The two-port embodiment is used with the closed-end pumping mechanism. The first port connects the inner tube to the tire. In this embodiment there is only one port connecting the inner tube and tire and the port acts as both the low-pressure and high-pressure port. The second port connects the inner tube to the control module.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1) A self-inflating tire, comprising:
a) a pneumatic tire, wherein said tire comprises a tread, and a casing, wherein said tread comprises an outer riding surface, wherein said casing comprises an inner inflation surface; and
b) an elastic inflation lumen, wherein said inflation lumen is disposed between said casing and said tread, wherein said inflation lumen comprises at least one air through-port.

2) The self-inflating tire according to claim 1, wherein said at least one air through-port is selected from the group consisting of an input port, an output port, and an input/output port (I/O port).

3) The self-inflating tire according to claim 1, wherein said inflation lumen comprises a closed-end inflation lumen, wherein said closed-end inflation lumen spans along at least a portion of a circumference of said pneumatic tire.

4) The self-inflating tire according to claim 1, wherein said inflation lumen comprises an open-end inflation lumen, wherein said open-end inflation lumen spans along at least a portion of a circumference of said pneumatic tire.

5) The self-inflating tire according to claim 1, wherein said tread comprises a channel, wherein said inflation lumen is disposed in said channel.

6) The self-inflating tire according to claim 1, wherein said pumping mechanism is configured to a tire selected from the group consisting of a tubeless tire, and a tubed tire.

7) The self-inflating tire according to claim 1 further comprising a compression layer, wherein said compression layer is disposed in a position selected from the group consisting of between said inflation lumen and said tread, and between said casing and said inflation lumen, wherein said compression layer comprises an actuator, wherein said actuator has a cross-section comprising a base and a converging tip, wherein said converging tip abuts an outer surface of said inflation lumen, wherein said compression layer comprises a length that spans along at least a portion of a circumference of said pneumatic tire.

8) The self-inflating tire according to claim 7, wherein said actuator comprises at least one ridge feature on said converging tip that is transverse to said compression layer length.

9) The self-inflating tire according to claim 7, wherein said compression layer comprises an interlocking actuator, wherein said interlocking actuator comprises a female actuator disposed on a first side of said inflation lumen and a male actuator disposed on a second side of said inflation lumen, wherein said first side is opposite said second side, wherein said interlocking actuator is configure to impart a surrounding-force directed to maintain alignment between said inflation lumen and said actuator.

10) The self-inflating tire according to claim 7, wherein said compression layer comprises a lower hardness than a hardness of said tread.

11) The self-inflating tire according to claim 1, wherein said inflation lumen is disposed along a circumference of said pneumatic tire.

12) The self-inflating tire according to claim 1 further comprising an inflation lumen protection layer disposed between said inflation lumen and said tread.

13) The self-inflating tire according to claim 1, wherein said inflation lumen comprises a block shape cross-section, wherein said block shape cross-section comprises a channel forming said lumen.

14) The self-inflating tire according to claim 1 further comprising a valve, wherein said valve is selected from the group consisting of a membrane valve, a 3-way valve, and a 2-way valve.

15) The self-inflating tire according to claim 14 further comprising connector tubing, wherein said connector tubing is disposed between said lumen and said valve.

16) The self-inflating tire according to claim 15, wherein said connector tubing comprises an accumulator, wherein said accumulator stores a volume of air between said lumen and said valve.

17) The self-inflating tire according to claim 15, wherein said valve is connected to an inner tube, wherein said inner tube connection comprises a controller connected between said inflation lumen and said valve of said inner tube.

18) The self-inflating tire according to claim 1 further comprising a valve and an actuator pressure governor, wherein said actuator pressure governor comprises an adjustable air input/output port.

19) The self-inflating tire according to claim 1 further comprising a controller, wherein said controller is selected from the group consisting of a removable controller, an adjustable pressure controller, and a fixed pressure controller.

20) The self-inflating tire according to claim 19, wherein said controller is disposed in a location inside an inner tube.
